(19) United States
(12) Patent Application Publication
(10) Pub. No.: US 2022/0227032 A1
(43) Pub. Date: Jul. 21, 2022

(54) INJECTION MOLD

(71) Applicant: HONDA MOTOR CO., LTD., Tokyo (JP)

(72) Inventor: Hiroshi Matsushima, Tokyo (JP)

(21) Appl. No.: 17/562,077

(22) Filed: Dec. 27, 2021

(30) Foreign Application Priority Data
Jan. 15, 2021 (JP) 2021-005301

(51) Int. Cl. B29C 45/26

(52) U.S. Cl. CPC B29C 45/26; B29L 2031/3044

(57) ABSTRACT

An injection mold is capable of molding a molded article. The molded article has a substantially U-shaped cross section when viewed from the horizontal direction of a fixed mold and a movable mold. An end portion of a side surface portion of the molded article includes an undercut portion inclined relative to the mold closing direction of the fixed mold and the movable mold. In the injection mold, a first mold, which is one of the fixed mold or the movable mold, includes a convex portion protruding toward a second mold, which is the other of the fixed mold and the movable mold. The protruding end of the convex portion is located at a position shifted from an insert in a direction from the first mold toward the second mold.

### CROSS-REFERENCE TO RELATED APPLICATIONS

This application is based upon and claims the benefit of priority from Japanese Patent Application No. 2021-005301 filed on Jan. 15, 2021, the contents of which are incorporated herein by reference.

### BACKGROUND OF THE INVENTION

### Field of the Invention

The present invention relates to an injection mold for obtaining a molded article by filling a cavity with a molten resin.

### Description of the Related Art

Resin molded articles are generally used for exterior parts or interior parts of automobile bodies. In the manufacturing process of the resin molded article, a cavity of an injection mold is filled with a molten resin. Thereafter, the molten resin is cooled and solidified in the cavity. Thus, the resin molded article is manufactured.

For example, there is a case where a large-sized resin molded article such as an automobile bumper is injection-molded. At this time, the side surface of the bumper, which is the lateral side of the vehicle, is deformed so as to open outward (outward in the vehicle width direction) by the pressure of the filled resin material. Along with the outward deformation of the side surface of the bumper, the fixed mold and the movable mold constituting the injection mold are deformed. As a result, a step occurs at a boundary portion between the fixed mold and the movable mold. There is a problem that a line is formed on an appearance design surface of the side surface of the bumper due to the occurrence of the step.

In order to solve the above-described problem, an injection mold disclosed in JP S61-015119 U includes a partial insert which is a part of a movable mold. When molding a bumper using the injection mold, an undercut portion is molded in a wheel arch portion between the partial insert and a fixed mold. The wheel arch portion constitutes the side surface of the bumper. The injection mold includes a convex portion on an outer side of the partial insert. The convex portion protrudes from a lower end of the fixed mold. When the movable mold and the fixed mold are closed to mold the bumper (molded article), the partial insert is pressed outward along with deformation of the side surface of the bumper. Outward movement of the partial insert is prevented by the convex portion. As a result, when the bumper is molded, the occurrence of a step on the side surface of the bumper that is an appearance design surface is suppressed.

In the injection mold disclosed in JP S61-015119 U, deformation of the movable mold and movement of the partial insert are suppressed by the convex portion of the fixed mold. Further, the fixed mold and the movable mold are separated in the mold closing direction of the injection mold. For this reason, when the wheel arch portion (undercut portion) is formed on a surface inclined with respect to the mold closing direction of the movable mold and the fixed mold, it is difficult to suppress the occurrence of a step in the entire region of the wheel arch portion (undercut portion).

### SUMMARY OF THE INVENTION

An object of the present invention is to solve the above-described problem.

According to an aspect of the present invention, provided is an injection mold comprising a fixed mold, and a movable mold configured to approach and separate from the fixed mold, the injection mold being configured to mold a molded article including a bottom surface portion perpendicular to a mold closing direction of the fixed mold and the movable mold, and a side surface portion inclined with respect to the bottom surface portion, the molded article being formed so as to have a substantially U-shaped cross section when viewed from a direction orthogonal to the mold closing direction, wherein the molded article includes, at an end portion of the side surface portion, an undercut portion inclined with respect to the mold closing direction, the injection mold further comprises an insert configured to mold the undercut portion in the side surface portion, and a cavity that is defined by the fixed mold, the movable mold, and the insert, and is filled with a molten resin, a first mold, which is one of the fixed mold or the movable mold, includes a convex portion protruding toward a second mold, which is another of the fixed mold and the movable mold, and a protruding end of the convex portion is located at a position shifted from the insert in a direction from the first mold toward the second mold.

According to the present invention, the injection mold includes the convex portion protruding toward the second mold, which is the other of the fixed mold and the movable mold. The protruding end of the convex portion is arranged at a position shifted from the insert in a direction from the first mold toward the second mold. When the cavity is filled with the molten resin to mold the molded article, the pressure of the molten resin is applied in a direction in which the molded article having a substantially U-shaped cross section opens. At this time, the convex portion is engaged with the second mold. Therefore, even when the undercut portion is inclined with respect to the side surface portion of the molded article, deformation of the second mold and movement of the insert can be suitably suppressed by the convex portion.

As a result, in the injection mold capable of molding a molded article having a substantially U-shaped cross section, deformation of the second mold, which is the other of the fixed mold and the movable mold, and movement of the insert during molding can be suppressed. Therefore, it is possible to suppress the occurrence of a step in the appearance in the vicinity of the undercut portion of the molded article. This makes it possible to improve the quality of the molded article.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall front view of an injection mold and a molded article according to an embodiment of the present invention, as viewed from a mold closing direction;

FIG. 2 is a cross-sectional view taken along line II-II of FIG. 1;

FIG. 3 is an enlarged cross-sectional view of the vicinity of one end in the width direction of the injection mold in FIG. 2; and

FIG. 4 is a side view of the injection mold and the molded article shown in FIG. 1 as viewed from one side in the width direction.

### DESCRIPTION OF THE INVENTION

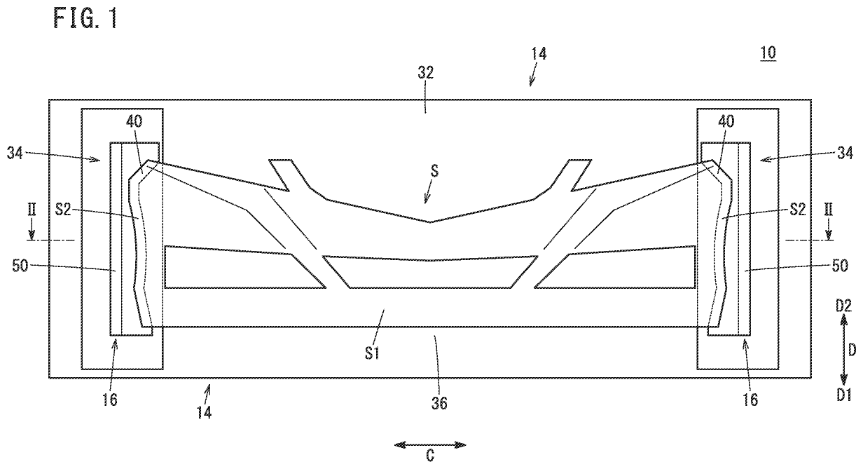

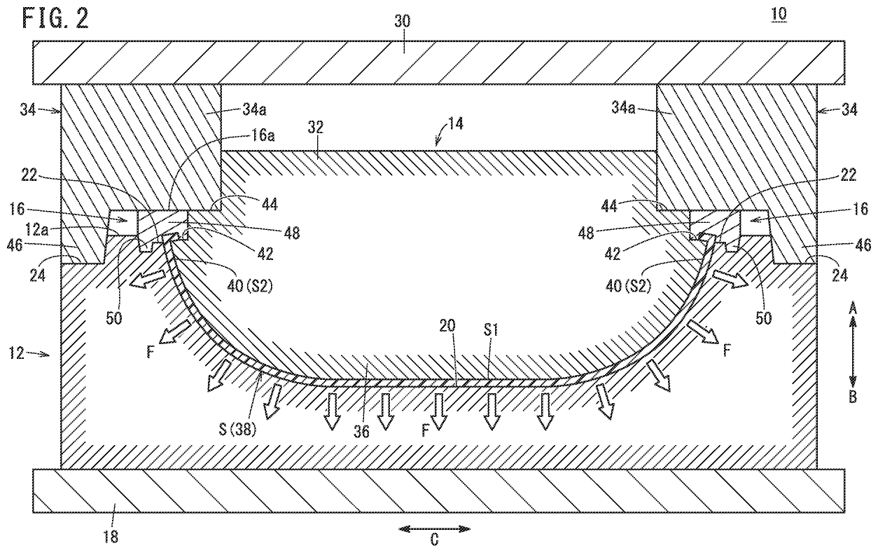

As shown in FIGS. 1 and 2, with an injection mold 10, for example, a bumper (molded article S) for an automobile is molded. The injection mold 10 includes a fixed mold 12, a movable mold 14, and inserts 16. The movable mold 14 is disposed above the fixed mold 12 (in an arrow A direction in FIG. 2). The movable mold 14 can approach or separate from the fixed mold 12. When a displacement mechanism (not shown) (for example, a hydraulic cylinder or the like) is driven, the movable mold 14 moves in a direction toward the fixed mold 12 (an arrow B direction in FIG. 2) or a direction away from the fixed mold 12 (the arrow A direction in FIG. 2). The inserts 16 are disposed between the fixed mold 12 and the movable mold 14. FIG. 1 is a front view of the movable mold 14 and the molded article S as viewed from the fixed mold 12.

In the following description, in the injection mold 10, a mold opening direction (upward) of the movable mold 14 is defined as the arrow A direction. A mold closing direction (downward) of the movable mold 14 is defined as the arrow B direction. A width direction orthogonal to the mold opening direction of the movable mold 14 is defined as an arrow C direction. A horizontal direction orthogonal to the width direction is defined as an arrow D direction (see FIG. 1).

The fixed mold 12 is fixed to a work station or the like (not shown) via a fixed platen 18. The fixed platen 18 has a plate shape and extends in the width direction. The fixed mold 12 has a recessed part 20. The recessed part 20 is disposed on a dividing surface 12a of the fixed mold 12 that faces the movable mold 14. The recessed part 20 is recessed in a direction (the arrow B direction) away from the movable mold 14. When viewed from a direction (horizontal direction) orthogonal to the mold closing direction shown in FIG. 2, the center of the recessed part 20 in the width direction extends substantially in the horizontal direction (width direction). The cross-sectional shape of the recessed part 20 is a shape gently curved in a direction approaching the movable mold 14 (the arrow A direction), from the center in the width direction toward both ends in the width direction.

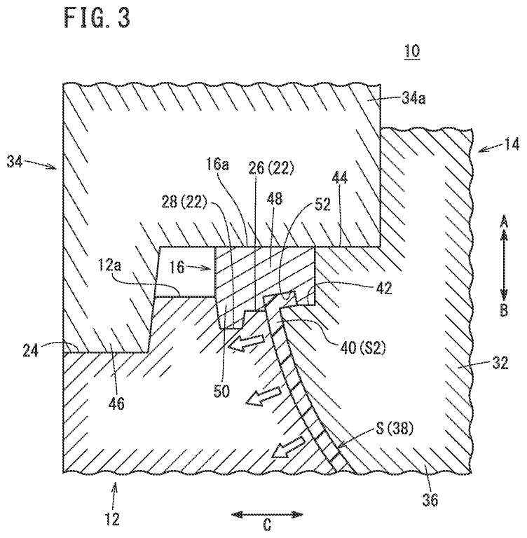

As shown in FIGS. 2 and 3, the fixed mold 12 includes two first groove portions (recessed portions) 22 and a second groove portion 24. The two first groove portions 22 are recessed in the dividing surface 12a of the fixed mold 12 at both ends in the width direction.

The first groove portion 22 is disposed adjacent to the recessed part 20. The first groove portion 22 includes a shallow groove portion 26 and a deep groove portion (recessed portion) 28. The shallow groove portion 26 is disposed in the first groove portion 22 on the inner side in the width direction (at a position closer to the recessed part 20 than the deep groove portion 28). The deep groove portion (recessed portion) 28 is disposed in the first groove portion 22 on the outer side in the width direction (at a position farther from the recessed part 20 than the shallow groove portion 26).

The second groove portion 24 is disposed in the dividing surface 12a on the outer side in the width direction than the first groove portion 22. The second groove portion 24 is more recessed than the first groove portion 22 in the dividing surface 12a.

The depth of the deep groove portion 28 is a depth from the dividing surface 12a. The depth of the shallow groove portion 26 is a depth from the dividing surface 12a. The depth of the deep groove portion 28 is greater than the depth of the shallow groove portion 26.

The cross-sectional shape of the second groove portion 24 is, for example, a substantially rectangular shape. The second groove portion 24 penetrates from one end to the other end of the fixed mold 12 in the width direction.

The movable mold 14 is coupled to the displacement mechanism (not shown) via a movable platen 30. The movable platen 30 has a plate shape. The movable mold 14 includes a movable main body 32 and movable spacers 34. The movable main body 32 is inserted into the recessed part 20 of the fixed mold 12. The movable spacers 34 are engaged with both ends of the movable main body 32 in the width direction. The movable main body 32 includes a convex part 36. The convex part 36 is disposed on a dividing surface facing the fixed mold 12. The convex part 36 protrudes in a direction (the arrow B direction) from the movable mold 14 toward the fixed mold 12.

The convex part 36 is disposed at a position facing the recessed part 20 of the fixed mold 12. The cross-sectional shape of the convex part 36 is a shape corresponding to the shape of the bumper that is the molded article S. The center of the convex portion 36 in the width direction extends in a substantially horizontal direction (width direction). The cross-sectional shape of the convex part 36 is gently curved in a direction away from the fixed mold 12, from the center in the width direction toward both ends in the width direction. In other words, the cross-sectional shape of the convex part 36 is a shape corresponding to the cross-sectional shape of the recessed part 20.

The movable mold 14 approaches the fixed mold 12, and the convex part 36 enters the recessed part 20. Thus, a cavity 38 is formed between the movable mold 14 and the fixed mold 12. The cavity 38 has a shape corresponding to the shape of the bumper that is the molded article S. The cavity 38 is a space having a predetermined width between the movable mold 14 and the fixed mold 12.

When viewed from the horizontal direction of the injection mold 10 shown in FIG. 2, the cross-sectional shape of the cavity 38 is a substantially U-shape recessed toward the fixed mold 12. The central portion of the cavity 38 in the width direction is the vehicle width center (a bottom surface portion S1) of the bumper that is the molded article S. Both ends of the cavity 38 in the width direction are side surface portions S2 that are outer sides of the bumper in the vehicle width direction. The side surface portions S2 each include a wheel arch portion 40 inclined with respect to the bottom surface portion S1 of the bumper. The wheel arch portion 40 surrounds an outer periphery of a tire (not shown) on the lateral side of a vehicle (not shown) with a predetermined distance therebetween.

In the cavity 38, the direction toward the fixed mold 12 (the arrow B direction) is the direction toward the vehicle front side in the bumper. In the cavity 38, the direction toward the movable mold 14 (the arrow A direction) is the direction toward the vehicle rear side in the bumper. In the cavity 38, the horizontal direction (the arrow D direction) orthogonal to the width direction is the vehicle vertical direction in the bumper.

Both ends of the movable main body 32 in the width direction are each provided with a first step portion 42 and a second step portion 44. The inserts 16 are engaged with the first step portions 42. The second step portions 44 are disposed above the first step portions 42. The movable spacers 34 are engaged with the second step portions 44.

When viewed from a direction orthogonal to the mold closing direction of the injection mold 10 shown in FIG. 2, the cross-sectional shape of the first step portion 42 is rectangular. The first step portions 42 are recessed inward in the width direction by a predetermined distance from both ends of the movable main body 32 in the width direction.

When viewed from the horizontal direction of the injection mold 10 shown in FIG. 2, the cross-sectional shape of the second step portion 44 is, for example, a substantially rectangular shape. The second step portions 44 are recessed inward in the width direction by a predetermined distance from both ends of the movable main body 32 in the width direction. The second step portion 44 is recessed more inward in the width direction than the first step portion 42.

Each of the first and second step portions 42 and 44 extends along the width direction (the arrow C direction) orthogonal to the mold opening direction of the movable mold 14. Each of the first and second step portions 42 and 44 is horizontal along the width direction. The first step portion 42 and the second step portion 44 are stepped in the height direction (the directions of arrows A and B).

The movable spacers 34 are arranged in pairs on the outer side of the movable main body 32 in the width direction. Each of the movable spacers 34 includes a spacer main body 34a and a first protruding portion (convex portion) 46. When viewed from the horizontal direction of the injection mold 10 shown in FIG. 2, the cross-sectional shape of the spacer main body 34a is substantially rectangular. The first protruding portion 46 is disposed at the outer end of the spacer main body 34a in the width direction. The first protruding portion 46 protrudes toward the fixed mold 12 (in the arrow B direction).

Each of the spacer main body 34a and the first protruding portion 46 is inclined at a predetermined angle with respect to the horizontal direction (the arrow D direction) orthogonal to the width direction of the injection mold 10.

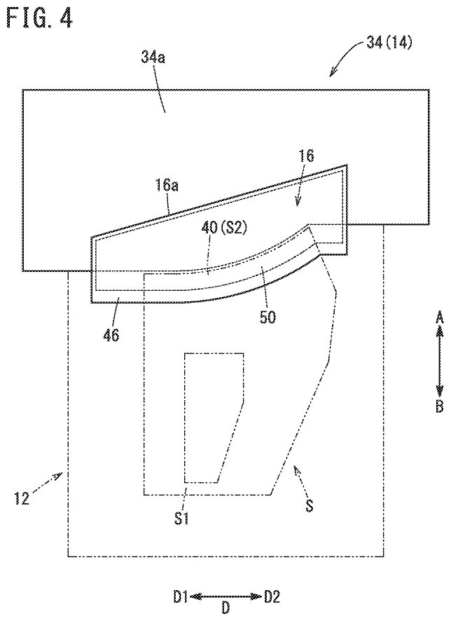

As shown in FIG. 4, the spacer main body 34a and the first protruding portion 46 are inclined in a direction (the arrow A direction) away from the fixed mold 12, from one end in the horizontal direction, which is the lower side in the vehicle direction in the bumper (molded article S), toward the other side in the horizontal direction (in the arrow D2 direction) orthogonal to the width direction. The inclination angle of the spacer main body 34a and the first protruding portion 46 is an angle along the wheel arch portion 40 of the bumper. That is, the first protruding portion 46 has a substantially constant height in the mold closing direction of the injection mold 10 (the arrow B direction).

The inner end of the spacer main body 34a in the width direction is engaged with the second step portion 44 of the movable main body 32. The first protruding portion 46 is engaged with the second groove portion 24 of the fixed mold 12. Thus, the movable spacers 34 are disposed across the movable main body 32 and the fixed mold 12. Correspondingly to the movable spacer 34, the second step portion 44 and the second groove portion 24 are inclined in a direction (the arrow A direction) away from the fixed mold 12, from one side in the horizontal direction (the arrow D1 side) toward the other side in the horizontal direction (the arrow D2 side).

As shown in FIGS. 1 to 4, with the insert 16, an end portion of the wheel arch portion 40 in the molded article S is molded. The end portion of the wheel arch portion 40 is an undercut portion. The insert 16 is a block body. The insert 16 includes a dented portion 52. The dented portion 52 is a part of the cavity 38. The inserts 16 are disposed as a pair on the outer side of the movable main body 32 in the width direction.

Each of the inserts 16 includes a main body portion 48 and a second protruding portion (protruding portion) 50. When viewed from the horizontal direction orthogonal to the width direction of the injection mold 10 shown in FIG. 2, the cross-sectional shape of the main body portion 48 is substantially rectangular. The second protruding portion 50 protrudes toward the fixed mold 12 from the outer end of the main body portion 48 in the width direction. The insert 16 is disposed across the first step portion 42 of the movable main body 32 and the first groove portion 22 of the fixed mold 12.

As shown in FIG. 4, the insert 16 includes a lower end directed toward the fixed mold 12 and the movable main body 32. The lower end of the insert 16 has a cross-sectional shape corresponding to the wheel arch portion 40 of the bumper (molded article S). The lower end of the insert 16 has an arc-shaped cross section that curves away from the fixed mold 12, from one end in the horizontal direction orthogonal to the width direction toward the other side in the horizontal direction (the arrow D2 direction). An upper end 16a of the insert 16 abuts against the movable spacer 34. The upper end 16a of the insert 16 is inclined at a predetermined angle correspondingly to the lower surface of the movable spacer 34 and is brought into surface contact with the lower surface of the movable spacer 34.

As shown in FIGS. 2 to 4, the insert 16 is located at a position shifted in the mold opening direction (the arrow A direction) from the protruding end of the first protruding portion 46 over the entire region from one end in the horizontal direction orthogonal to the width direction toward the other side in the horizontal direction (the arrow D2 direction). The height of the insert 16 is a height that allows the insert 16 to be housed in the movable mold 14. The protruding end of the first protruding portion 46 is located at a position shifted in the mold closing direction from the insert 16.

The main body portion 48 includes the dented portion 52. The dented portion 52 is disposed on the lower surface of the inner end in the width direction engaged with the first step portion 42. The dented portion 52 is dented upward (in the arrow A direction) from the lower surface of the main body portion 48, to a predetermined depth. The cross-sectional shape of the dented portion 52 is, for example, a rectangular shape elongated in the width direction. The depth of the dented portion 52 is constant along the width direction. The inner end of the dented portion 52 in the width direction communicates with a gap between the recessed part 20 of the fixed mold 12 and the convex part 36 of the movable main body 32. Thus, the dented portion 52 constitutes a part of the cavity 38. That is, the dented portion 52 extends along the curved surface of the lower end of the insert 16.

The second protruding portion 50 protrudes from the lower end of the main body portion 48 toward the fixed mold 12 by a predetermined height. When viewed from the width direction of the injection mold 10 shown in FIG. 4, the second protruding portion 50 is disposed on the outer side than the wheel arch portion 40 of the bumper. When viewed from the width direction of the injection mold 10 shown in FIG. 4, the cross-sectional shape of the second protruding portion 50 is an arc shape.

The outer side of the insert 16 in the width direction is engaged with the first groove portion 22 of the fixed mold 12. The second protruding portion 50 of the insert 16 is inserted into and engaged with the deep groove portion 28. The upper end 16a of the main body portion 48 of the insert 16 is brought into surface contact with the lower surface of the movable spacer 34 disposed thereabove. Similarly to the movable spacers 34, the inserts 16 are disposed across the movable main body 32 of the movable mold 14 and the fixed mold 12.

In addition, in the injection mold 10 described above, a case in which the movable mold 14 is provided with the first protruding portion (convex portion) 46 has been described, but the present invention is not limited to a configuration in which the movable mold 14 is provided with the first protruding portion 46. The first protruding portion 46 may be provided on the fixed mold 12.

Next, the operation and effects of the injection mold 10 will be described.

First, the displacement mechanism (not shown) is driven to lower the movable mold 14 of the injection mold 10. The movable mold 14 approaches the fixed mold 12. As shown in FIG. 2, the dividing surface of the movable mold 14 and the dividing surface 12a of the fixed mold 12 are brought into contact with each other. As the movable mold 14 is lowered, the convex part 36 enters the recessed part 20. As the movable mold 14 is lowered, the first protruding portion 46 of the movable spacer 34 is inserted into the second groove portion 24. As the movable mold 14 is lowered, the second protruding portion 50 of the insert 16 is inserted into the deep groove portion 28 of the fixed mold 12. As a result, the injection mold 10 is closed to form the cavity 38 between the movable mold 14 and the fixed mold 12.

Next, a molten resin is supplied to the cavity 38 from an injection machine (not shown). The molten resin is filled into the cavity 38. The molten resin is filled into the dented portions 52 of the inserts 16 on both ends sides of the injection mold 10 in the width direction. In this manner, the cavity 38 is filled with the molten resin.

In the cavity 38, the pressure of the molten resin (resin pressure) (see F in FIG. 2) is applied toward the fixed mold 12 disposed outside the cavity 38. At this time, the first protruding portions 46 of the movable spacers 34 and the second protruding portions 50 of the inserts 16 are inserted into the fixed mold 12 at both ends of the cavity 38 in the width direction. As a result, deformation of the fixed mold 12 is suitably suppressed by the first and second protruding portions 46 and 50 in the vicinity of both ends of the cavity 38 in the width direction. That is, the first and second protruding portions 46 and 50 serve as stoppers that suppress deformation of the fixed mold 12 outward in the width direction.

Then, the molten resin is cooled for a predetermined time period in a state where the cavity 38 is filled with the molten resin. As the molten resin is cooled, it solidifies in the cavity 38. Thus, in the injection mold 10, the molded article S (bumper for automobile) corresponding to the shape of the cavity 38 is obtained. At this time, on the side surface portion S2 of the bumper, the inner end of the wheel arch portion 40 that is bent inward in the width direction is molded by the insert 16. Deformation in the vicinity of both ends of the fixed mold 12 in the width direction is suppressed by the inserts 16. Therefore, displacement in the width direction (the arrow C direction) between the lower end of the insert 16 and the fixed mold 12 is suppressed. As a result, displacement in the width direction between the insert 16 and the fixed mold 12 is suitably prevented. Accordingly, the occurrence of a step in the vicinity of the wheel arch portion 40 in the bumper is suitably prevented.

Finally, the displacement mechanism (not shown) is driven to raise the movable mold 14. The movable mold 14 is separated upward from the fixed mold 12 by a predetermined distance and the injection mold 10 is opened. Thereafter, an ejector mechanism (not shown) is driven and the molded article S is pressed by the ejector mechanism. The pressing direction of the molded article S is a direction (downward, the arrow B direction) in which the molded article S is separated from the movable mold 14. As a result, the bumper, which is the molded article S, is pressed by the ejector mechanism, released from the movable mold 14, and taken out downward.

As described above, in the present embodiment, the molded article S having a substantially U-shaped cross section with a large size such as a bumper for an automobile is molded in the injection mold 10. The side surface portion S2 of the molded article S includes the undercut portion at the end portion of the wheel arch portion 40. The undercut portion is inclined with respect to the mold closing direction of the fixed mold 12 and the movable mold 14. The injection mold 10 is provided with the inserts 16 for molding the undercut portion. The movable spacers 34 of the movable mold 14 each include the first protruding portion 46. The protruding end (lower end) of the first protruding portion 46 is located at a position shifted in the mold closing direction from the insert 16. The first protruding portion 46 suppresses outward deformation of the fixed mold 12 due to the pressure F (resin pressure) of the molten resin filled in the cavity 38.

When the molded article S is molded in the injection mold 10, the pressure F of the molten resin is applied to the fixed mold 12 in a direction (outward) in which the molded article S having a substantially U-shaped cross section opens. At this time, the first protruding portion 46 protrudes further toward the fixed mold 12 than the insert 16 over the entire region from one end in the horizontal direction orthogonal to the width direction toward the other side in the horizontal direction (the arrow D2 direction) in the injection mold 10. Therefore, the first protruding portion 46 is inserted into and engaged with the fixed mold 12. Accordingly, deformation of the fixed mold 12 in the vicinity of both sides in the width direction of the bumper having the undercut portions is suitably suppressed.

As a result, when the molded article S having a substantially U-shaped cross section such as a bumper for an automobile is molded, deformation of the fixed mold 12 can be suppressed. Accordingly, it is possible to suppress the occurrence of a step in the appearance in the vicinity of the undercut portion of the bumper. Therefore, the quality of the bumper can be improved.

The first protruding portion 46 of the movable spacer 34 has a substantially constant height in the mold closing direction of the injection mold 10. Therefore, when the pressure F of the molten resin is applied to the first protruding portion 46 via the fixed mold 12 during molding of the molded article S, the amount of deformation (amount of inclination) of the first protruding portion 46 outward in the width direction can be made substantially constant in the horizontal direction (the arrow D direction). As a result, in the side surface portion S2 of the bumper that is the molded article S, the undercut portion (the wheel arch portion 40) molded along the horizontal direction can be uniformly finished.

The movable spacer 34 of the movable mold 14 includes the first protruding portion 46. The fixed mold 12 includes the insert 16. The insert 16 includes the dented portion 52 that is a part of the cavity 38. By arranging the insert 16 so as to face the movable mold 14, deformation or movement of the insert 16 can be suppressed by the first protruding portion 46. Therefore, when the molded article S is molded in the injection mold 10, it is possible to more reliably suppress the occurrence of a step in the appearance of the bumper.

The insert 16 includes the second protruding portion 50 protruding toward the fixed mold 12. The fixed mold 12 includes the first groove portion 22 (deep groove portion 28) into which the second protruding portion 50 is inserted. As a result, when the fixed mold 12 is pressed outward in the width direction by the pressure F of the molten resin during injection molding of the bumper, the insert 16 follows the fixed mold 12 and moves outward in the width direction integrally with the fixed mold 12. Therefore, displacement in the width direction between the insert 16 and the fixed mold 12 is suppressed at a boundary portion between the insert 16 and the fixed mold 12. As a result, at the boundary portion between the insert 16 and the fixed mold 12, it is possible to suppress the occurrence of a step in the appearance of the bumper that is the molded article S.

The molded article S obtained by the injection mold 10 is a bumper for an automobile. The mold closing direction of the injection mold 10 is the front-rear direction of the automobile. The undercut portion of the bumper is the wheel arch portion 40 and is formed on the side surface portion S2 of the molded article S. As a result, in the molding in the injection mold 10, it is possible to prevent the occurrence of molding marks on the appearance design surface of the wheel arch portion 40.

The above embodiment can be summarized as follows.

The above embodiment relates to an injection mold (10) comprising a fixed mold (12), and a movable mold (14) configured to approach and separate from the fixed mold, the injection mold being configured to mold a molded article (S) including a bottom surface portion (S1) perpendicular to a mold closing direction of the fixed mold and the movable mold, and a side surface portion (S2) inclined with respect to the bottom surface portion, the molded article being formed so as to have a substantially U-shaped cross section when viewed from a direction orthogonal to the mold closing direction, wherein the molded article includes, at an end portion of the side surface portion, an undercut portion inclined with respect to the mold closing direction, the injection mold further comprises an insert (16) configured to mold the undercut portion in the side surface portion, and a cavity (38) that is defined by the fixed mold, the movable mold, and the insert and is filled with a molten resin, a first mold, which is one of the fixed mold or the movable mold, includes a convex portion (46) protruding toward a second mold, which is another of the fixed mold and the movable mold, and a protruding end of the convex portion is located at a position shifted from the insert in a direction from the first mold toward the second mold.

In the above-described embodiment, the injection mold includes the convex portion protruding toward the second mold which is the other of the fixed mold and the movable mold. The protruding end of the convex portion is arranged at a position shifted from the insert in a direction from the first mold toward the second mold. When the cavity is filled with the molten resin to mold the molded article, the pressure of the molten resin is applied in a direction in which the molded article having a substantially U-shaped cross section opens. At this time, the convex portion is engaged with the second mold. Therefore, even when the undercut portion is inclined with respect to the side surface portion of the molded article, deformation of the second mold and movement of the insert can be suitably suppressed by the convex portion.

As a result, in the injection mold capable of molding the molded article having a substantially U-shaped cross section, deformation of the second mold, which is the other of the fixed mold and the movable mold, and movement of the insert during molding can be suppressed. Therefore, it is possible to suppress the occurrence of a step in the appearance in the vicinity of the undercut portion of the molded article. This makes it possible to improve the quality of the molded article.

The convex portion is formed at a constant height in the mold closing direction. Therefore, when the pressure of the molten resin is applied to the convex portion via the second mold during molding of the molded article, the amount of deformation (amount of inclination) of the convex portion outward in the width direction can be made substantially constant in the horizontal direction. As a result, in the molded article, the undercut portion formed along the horizontal direction can be finished uniformly.

The movable mold includes the convex portion, and the insert is disposed in the movable mold to form the cavity in the fixed mold. Accordingly, by disposing the insert in the movable mold, deformation or movement of the insert can be suppressed by the convex portion. Therefore, when the molded article is molded in the injection mold, a step occurring in the appearance of the molded article can be more reliably suppressed.

The insert includes a protruding portion protruding toward the fixed mold, and the fixed mold includes a recessed portion into which the protruding portion is inserted. Thus, when the fixed mold is pressed outward in the width direction by the pressure of the molten resin during injection molding of the molded article, the insert follows the fixed mold and moves outward in the width direction integrally with the fixed mold. Therefore, at the boundary portion between the insert and the fixed mold, displacement in the width direction between the insert and the fixed mold is suppressed. As a result, it is possible to suppress a step occurring in the appearance of the molded article at the boundary portion between the insert and the fixed mold.

The molded article is a bumper for an automobile, the mold closing direction is a front-rear direction of the automobile, and the undercut portion is formed on a surface to be a wheel arch portion (40) of the bumper. As a result, when the bumper is molded in the injection mold, it is possible to prevent the occurrence of molding marks on the appearance design surface of the wheel arch portion.

Note that the present invention is not limited to the embodiment described above, and various configurations can be adopted therein without departing from the gist of the present invention.

What is claimed is:

1. An injection mold comprising a fixed mold, and a movable mold configured to approach and separate from the fixed mold, the injection mold being configured to mold a molded article including a bottom surface portion perpendicular to a mold closing direction of the fixed mold and the movable mold, and a side surface portion inclined with respect to the bottom surface portion, the molded article being formed so as to have a substantially U-shaped cross section when viewed from a direction orthogonal to the mold closing direction, wherein
the molded article includes, at an end portion of the side surface portion, an undercut portion inclined with respect to the mold closing direction,
the injection mold further comprises an insert configured to mold the undercut portion in the side surface portion, and a cavity that is defined by the fixed mold, the movable mold, and the insert, and is filled with a molten resin,
a first mold, which is one of the fixed mold or the movable mold, includes a convex portion protruding toward a second mold, which is another of the fixed mold and the movable mold, and
a protruding end of the convex portion is located at a position shifted from the insert in a direction from the first mold toward the second mold.

2. The injection mold according to claim 1, wherein
the convex portion is formed at a constant height in the mold closing direction.

3. The injection mold according to claim 1, wherein
the movable mold includes the convex portion, and the insert is disposed in the movable mold to form the cavity in the fixed mold.

4. The injection mold according to claim 3, wherein
the insert includes a protruding portion protruding toward the fixed mold, and
the fixed mold includes a recessed portion into which the protruding portion is inserted.

5. The injection mold according to claim 1, wherein
the molded article is a bumper for an automobile,
the mold closing direction is a front-rear direction of the automobile, and
the undercut portion is formed on a surface to be a wheel arch portion of the bumper.
